(19) United States
(12) Patent Application Publication
(10) Pub. No.: US 2019/0132468 A1
(43) Pub. Date: May 2, 2019

(54) IMAGE FORMING APPARATUS EQUIPPED WITH HDD, CONTROL METHOD THEREFOR, AND STORAGE MEDIUM

(71) Applicant: CANON KABUSHIKI KAISHA, Tokyo (JP)

(72) Inventor: Akitomo Fukui, Yokohama-shi (JP)

(21) Appl. No.: 16/167,675

(22) Filed: Oct. 23, 2018

(30) Foreign Application Priority Data
Oct. 27, 2017 (JP) 2017-208475

(51) Int. Cl. H04N 1/00; H04N 1/21

(52) U.S. Cl. CPC H04N 1/00954; H04N 2201/0094; H04N 1/2104; H04N 1/00896

(57) ABSTRACT

An image forming apparatus which is capable of improving performance without shortening the life span of an HDD. The image forming apparatus has the HDD stores data related to execution of a received job, and a volatile memory unit that holds data. Multiple pieces of data are generated in relation to execution of the job. The HDD stores data generated during a job execution time period during which the job is executed among the multiple pieces of data. The memory unit holds data generated at times other than the job execution time period among the multiple pieces of data.

### BACKGROUND OF THE INVENTION

### Field of the Invention

The present invention relates to an image forming apparatus, a control method therefor, and a storage medium, and in particular to an image forming apparatus equipped with an HDD, a control method therefor, and a storage medium.

### Description of the Related Art

An MFP which is an image forming apparatus equipped with an HDD is known. When, for example, executing a received print job, the MFP stores image data for use in printing and execution log data on the print job in the HDD. The MFP also stores log data indicating a status of the MFP (hereafter referred to as “the status log data”) in the HDD. The status log data includes information indicating an operating state of the MFP and information indicating statuses of consumables such as toner and sheets used by the MFP. Such information varies with execution of the print job, and hence the status log data is stored in the HDD after the execution of the print job is completed.

The HDD has a disk which is a magnetic recording medium, and a head which reads and writes data. In the HDD, the head floating slightly above a surface of the disk rotating at high speed is moved to each sector of the disk, and the head reads data recorded in the sector to which the disk moves or writes data into the sector. In the HDD, when reading and writing of data is completed, the head is usually retracted to a predetermined home position, but there has been proposed a technique to hold the head over the disk for a predetermined period of time without immediately retracting the head to the home position (see, for example, Japanese Laid-Open Patent Publication (Kokai) No. 2007-12250). According to this technique, as compared to the case where the head is retracted to the home position each time reading or writing of data is completed, the amount by which the head is moved to read or write data is reduced, and therefore, data is efficiently read from and written into the HDD. As a result, performance of the MFP is improved.

According to the technique described in Japanese Laid-Open Patent Publication (Kokai) No. 2007-12250, however, the life span of the HDD may be shortened even though performance of the MFP is improved. In general, the life span of the HDD decreases as the total time period during which the head stays over the disk increases. On the other hand, in the MFP, the status log data is written into the HDD not only during execution of a print job but also after execution of the print job is completed. For this reason, if the technique described in Japanese Laid-Open Patent Publication (Kokai) No. 2007-12250 is applied to a reading and writing process by the HDD in a print job, it would be necessary for the head to stay over the disk in the MFP until subsequent writing of the status log data is completed even if execution of the print job is completed. This would increase the total time period during which the head stays over the disk and shortens the life span of the HDD.

### SUMMARY OF THE INVENTION

The present invention provides an image forming apparatus and a control method therefor which are capable of improving performance without shortening the life span of an HDD, as well as a storage medium.

Accordingly, the present invention provides an image forming apparatus that executes a received job, comprising, a generating unit configured to generate multiple pieces of data related to execution of the job, a nonvolatile storage unit configured to store data, a volatile holding unit configured to hold data; and a control unit configured to cause the storage unit to store data generated during a job execution time period during which the job is executed among the multiple pieces of data, and cause the holding unit to hold data generated at times other than the job execution time period among the multiple pieces of data.

According to the present invention, performance of the image forming apparatus is improved without shortening the life span of the HDD.

Further features of the present invention will become apparent from the following description of exemplary embodiments (with reference to the attached drawings).

### BRIEF DESCRIPTION OF THE DRAWINGS

FIG. 1 is a block diagram schematically showing an arrangement of an MFP which is an image forming apparatus according to an embodiment of the present invention.

FIG. 2 is a block diagram schematically showing an arrangement of a main controller in FIG. 1.

FIG. 3 is a block diagram schematically showing an arrangement of an HDD in FIG. 2.

FIG. 4 is a flowchart showing the procedure of a flag setting process which is carried out by the main controller in FIG. 1.

FIG. 5 is a view useful in explaining how status log data is written by a conventional MFP.

FIG. 6 is a flowchart showing the procedure of an HDD writing process which is carried out by the main controller in FIG. 1.

FIG. 7 is a diagram useful in explaining determination as to a last page by the main controller in FIG. 1.

FIGS. 8A to 8C are diagrams useful in explaining how data is written by the main controller in FIG. 1.

FIG. 9 is a block diagram schematically showing an arrangement of a variation of the main controller in FIG. 1.

FIG. 10 is a flowchart showing the procedure of a variation of the flag setting process in FIG. 4.

FIG. 11 is a flowchart showing the procedure of a variation of the HDD writing process in FIG. 6.

### DESCRIPTION OF THE EMBODIMENTS

An embodiment of the present invention will now be described in detail with reference to the drawings. In the following description of the present embodiment, the present invention is applied to an MFP which is an image forming apparatus, but the present invention should not always be applied to the MFP but may be applied to information processing apparatuses such as a PC equipped with an HDD.

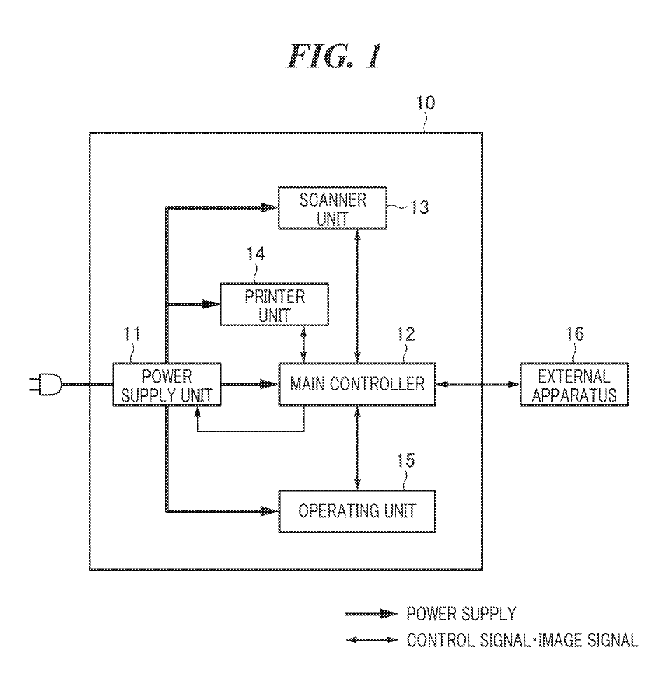

FIG. 1 is a block diagram schematically showing an arrangement of the MFP 10 which is the image forming apparatus according to the embodiment of the present invention.

Referring to FIG. 1, the MFP 10 has a power supply unit 11, a main controller 12, a scanner unit 13, a printer unit 14, and an operating unit 15. The main controller 12 is connected to the power supply unit 11, the scanner unit 13, the printer unit 14, and the operating unit 15.

The MFP 10 has a plurality of functions such as a printing function, a scanning function, a copying function, and a faxing function. The MFP 10 also has three types of operating modes, and more specifically, a job mode, a standby mode, and a sleep mode (power saving mode). The job mode is an operating mode in which a job is executed in accordance with an executing instruction issued by a user. The standby mode is an operating mode in which the MFP 10 waits for a job executing instruction. The sleep mode is an operating mode in which power consumption in the MFP 10 is minimized. When the MFP 10 shifts into the sleep mode, power is supplied only to modules related to power saving such as a sensor for return to sleep, not shown, among a plurality of modules provided in the MFP 10. The power supply unit 11 controls supply of power to the main controller 12, the scanner unit 13, the printer unit 14, and the operating unit 15. The main controller 12 integratedly controls the MFP 10. The scanner unit 13 optically reads an original placed thereon and generates image data based on image information obtained by reading the original. The printer unit 14 performs printing based on image data generated by the scanner unit 13 or print data obtained from an external apparatus 16. The operating unit 15 is a user interface of the MFP 10. The operating unit 15 receives instructions from the user.

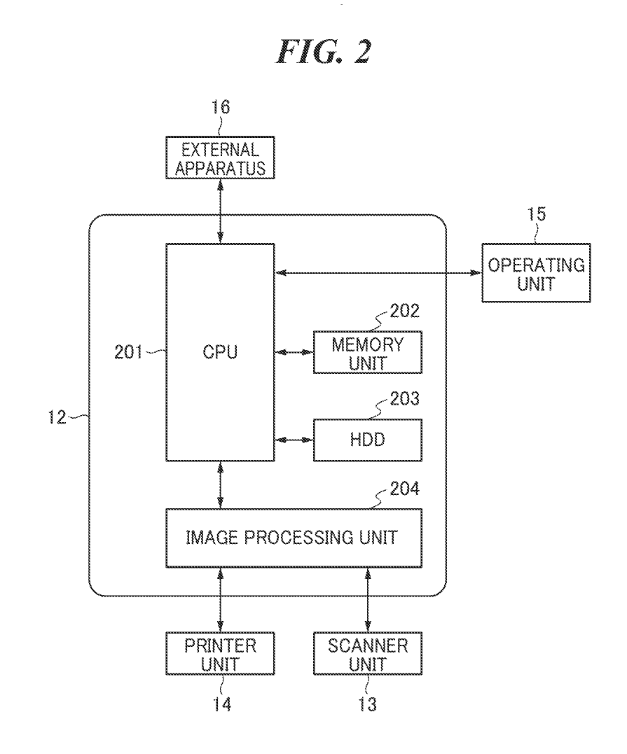

FIG. 2 is a block diagram schematically showing an arrangement of the main controller 12 in FIG. 1.

Referring to FIG. 2, the main controller 12 has a CPU 201, a memory unit 202, an HDD 203, and an image processing unit 204. The CPU 201 is connected to the memory unit 202, the HDD 203, and the image processing unit 204.

The CPU 201 provides various types of control in the MFP 10 by executing programs stored in the HDD 203. For example, the CPU 201 controls execution of a job in response to an instruction given by the user via the operating unit 15 or the external apparatus 16. The CPU 201 also controls processes in which data is read from and written into the HDD 203 as the job is executed. Further, when data transmitted by fax from the external apparatus 16 or the like is received, the CPU 201 provides control to write the received data in the HDD 203. The memory unit 202 is a volatile memory such as DDR and SDRAM. The memory unit 202 temporarily stores, for example, a job which is to be executed by the CPU 201.

The HDD 203 is a nonvolatile storage device which is capable of holding stored data even when no power is supplied to the HDD 203. The HDD 203 stores programs, execution log data on jobs, system management data, status log data on the MFP 10, and so forth. The system management data includes information about network settings on the MFP 10 and group settings related to authentication, a telephone book, and information about sleep settings. The status log data on the MFP 10 includes information indicating an operating state of the MFP 10 and information indicating statuses of consumables such as toner and sheets used by the MFP 10. The status log data varies with execution of the print job progresses, and hence the status log data is written into the HDD 203 after execution of the print job is completed. The HDD 203 is also used as a large-capacity work area to spool image data in each job. The image processing unit 204 performs image processing such as color space conversion on image data generated by the scanner unit 13. Data obtained as a result of the image processing is output from the image processing unit 204 to the CPU 201 or the printer unit 14.

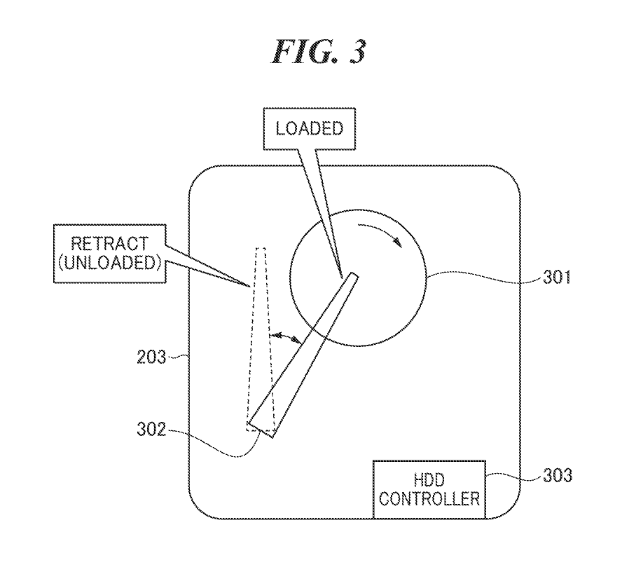

FIG. 3 is a block diagram schematically showing an arrangement of the HDD 203 in FIG. 1.

Referring to FIG. 3, the HDD 203 has a disk 301, a head 302, and an HDD controller 303. The disk 301 has a flat circular shape and is rotatably placed. The rotation of the disk 301 is controlled by the HDD controller 303. The head 302 moves to each sector of the disk 301 in a state of floating slightly above a surface of the rotating disk 301 and reads data recorded in each sector of the disk 301 or writes data in each sector of the disk 301. Upon finishing reading or writing data, the head 302 retracts to a home position defined in advance. The HDD controller 303 converts control commands for the HDD 203, which are received from the CPU 201, into SATA commands and outputs the SATA commands to the head 302 to control operations of the head 302. For example, when a data readout command is output from the CPU 201, the HDD controller 303 converts the data readout command into a SATA command and outputs the SATA command to the head 302. The head 302 moves to a sector indicated by the SATA command and reads data recorded in the sector. When a retraction command for the head 302 is output from the CPU 201, the HDD controller 303 converts the retraction command into a SATA command and outputs the SATA command to the head 302, causing the head 302 to retract to the home position. In the following description, a state in which the head 302 has retracted to the home position in the HDD 203 is referred to as an unloaded state. Also, a state in which the head 302 stays over the disk 302 is referred to as a loaded state.

A description will now be given of how a flag is set when the MFP 10 has received an instruction to execute a job. A plurality of job applications (not shown) is installed in the MFP 10. When the MFP 10 has received an instruction to execute a job, a job application in the MFP 10 which is associated with a type of the job among the plurality of job applications is started, and a flag is set to indicate that the job application is running.

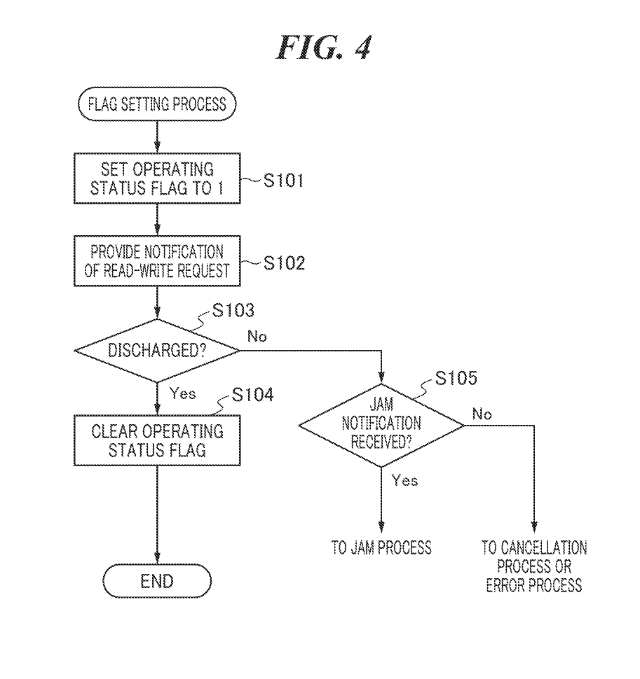

FIG. 4 is a flowchart showing the procedure of a flag setting process which is carried out by the main controller 12 in FIG. 1.

The process in FIG. 4 is implemented by the CPU 201 executing programs stored in the HDD 203. The process in FIG. 4 is based on the assumption that, for example, a flag is set for a print job application among the plurality of job applications installed in the MFP 10.

Referring to FIG. 4, first, upon receiving an instruction to execute a print job from the operating unit 15 or the external apparatus 16, the CPU 201 starts the print job application for executing the print job. The CPU 201 sets an operating status flag for the print job application to “1” which indicates that the print job application is running (step S101). Next, the CPU 201 notifies an OS (operating system) (not shown) of the MFP 10 of a read-write request for the HDD 203 (step S102). The OS is basic software for the MFP 10, which is executed by the CPU 201, and appropriately distributes resources of the HDD 203 and others according to priorities in the OS. The OS also manages operations according to privilege levels of applications. When the process in the step S102 is carried out, the print job is executed in the MFP 10. In the print job, each piece of data for use in printing is read from the HDD 203, and execution log data or the like on the print job is written into the HDD 203. Then, the CPU 201 determines whether or not printed matter which is an execution result of the print job has been discharged (step S103).

As a result of the determination in the step S103, when the printed matter has been discharged, the CPU 201 clears the operating status flag (step S104). For example, in a case where printing on a plurality of pages is performed, the CPU 201 clears the operating status flag when printed matter for a last page has been discharged. When the process in the step S104 is carried out, the operating status flag for the print job application is set to “0” which indicates that the print job application is not running. After that, the CPU 201 ends the present process.

As a result of the determination in the step S103, when the printed matter has not been discharged, the CPU 201 determines whether or not a jam notification has been received (step S105).

As a result of the determination in the step S105, when the jam notification has been received, the CPU 201 carries out a jam process to clear a jam. As a result of the determination in the step S105, when the jam notification has not been received, the CPU 201 carries out a cancellation process or an error process. The cancellation process is a process in which a print job under execution is canceled. The cancellation process is carried out when the user performs a cancelling operation. The error process is a process in which an error that has occurred is fixed. The error process is carried out when an error other than a jam has occurred.

To efficiently read and write data from and into the HDD 203, the MFP 10 causes the head 302 to stay over the disk 301 for a predetermined period of time, for example, during reading or writing of data associated with execution of the print job. This reduces the amount by which the head 302 moves while data recorded in the HDD 203 is read or data is written into the HDD 203 as the print job is executed, enabling the MFP 10 to efficiently read or write data from and into the HDD 203. As a result, performance of the MFP 10 is improved.

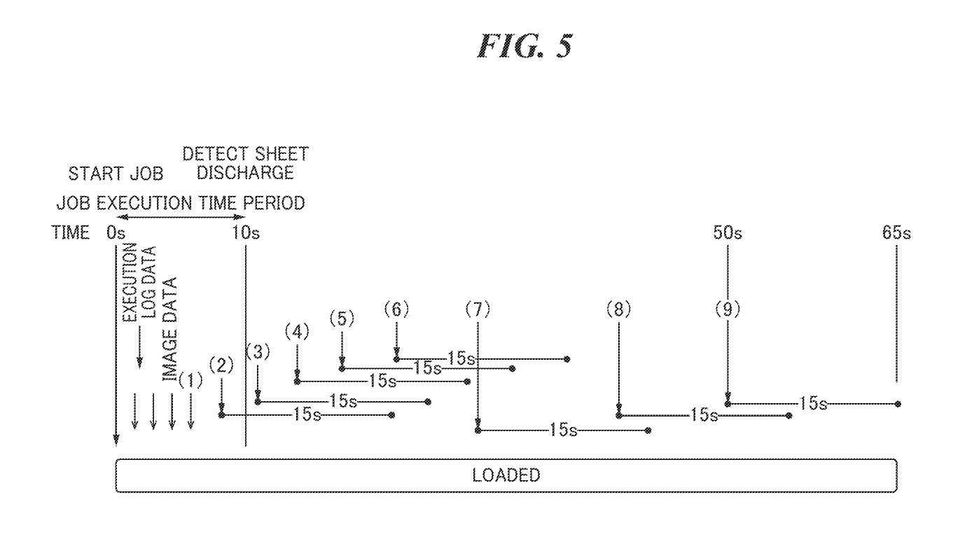

On the other hand, in the MFP 10, data is read from or written into the HDD 203 during execution of the print job, but even after execution of the print job is completed, status log data which varies with execution of the print job is also written into the HDD 203 (see, for example, (3) to (9) in FIG. 5). Namely, even after execution of the print job is completed, the loaded state is maintained in the MFP 10 so as to efficiently read and write data from and into the HDD 203 until writing of the status log data is completed. In general, the life span of the HDD 203 decreases as the total time for which the HDD 203 is in the loaded state (hereafter referred to as “the total loading time”) increases, and therefore, if the loaded state is maintained so as to efficiently read and write data from and into the HDD 203 as described above, the life span of the HDD 203 would decrease.

To cope with this, in the present embodiment, in the MFP 10 which writes multiple pieces of data associated with execution of a received job into the HDD 203, a part of the multiple pieces of data is written into the memory unit 202, not the HDD 203.

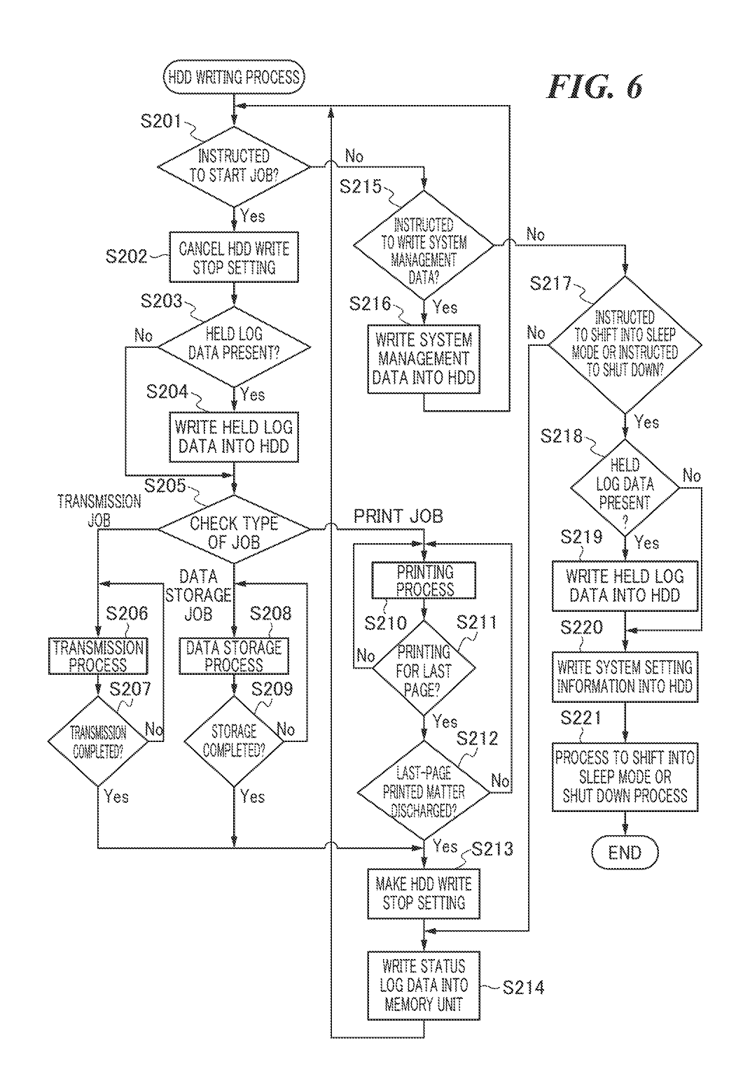

FIG. 6 is a flowchart showing the procedure of an HDD writing process which is carried out by the main controller 12 in FIG. 1.

The process in FIG. 6 is implemented by the CPU 201 of the main controller 12 executing programs stored in the HDD 203. The process in FIG. 6 is carried out when the MFP 10 shifts into the standby mode. The process in FIG. 6 is based on the assumption that an HDD write stop setting that does not permit writing of data into the HDD 203 is made in the MFP 10 in advance.

Referring to FIG. 6, first, the CPU 201 determines whether or not it has been instructed to start a job (step S201). In the step S201, when the operating status flag for any of the installed job applications is set to “1”, the CPU 201 determines that it has been instructed to start the job. On the other hand, when the operating status flags for all of the installed job applications are set to “0”, the CPU 201 determines that it has not been instructed to start the job.

As a result of the determination in the step S201, when the CPU 201 has been instructed to start the job, the CPU 201 cancels the HDD write stop setting (step S202). As a result, writing of data into the HDD 203 is allowed in the MFP 10. Next, the CPU 201 determines whether or not held log data, to be described later, is present (step S203).

As a result of the determination in the step S203, when the held log data is not present, the CPU 201 carries out a process in step S205, to be described later. On the other hand, as a result of the determination in the step S203, when the held log data is present, the CPU 201 writes the held log data into the HDD 203 (step S204) and finds a type of the job (step S205).

In the step S205, when the job is a transmission job in which image data is transmitted such as Scan to Send or fax transmission, the CPU 201 carries out a transmission process to transmit image data designated in the transmission job (step S206). In the transmission process, the CPU 201, for example, reads the image data from the HDD 203 or writes the image data and execution log data on the transmission process into the HDD 203. Then, the CPU 201 determines whether or not transmission of all the designated image data has been completed (step S207).

As a result of the determination in the step S207, when transmission of any of the designated image data has not been completed, the process returns to the step S206.

In the step S205, when the job is a data storage job in which image data is stored such as Scan to Box or fax memory reception, the CPU 201 carries out a data storage process (step S208). In the data storage process, the CPU 201, for example, reads targeted image data in the data storage job from the HDD 203 or writes the image data and execution log data on the data storage process into the HDD 203. Then, the CPU 201 determines whether or not storage of all the targeted image data has been completed (step S209).

As a result of the determination in the step S209, when any of the targeted image data has not been stored, the process returns to the step S208.

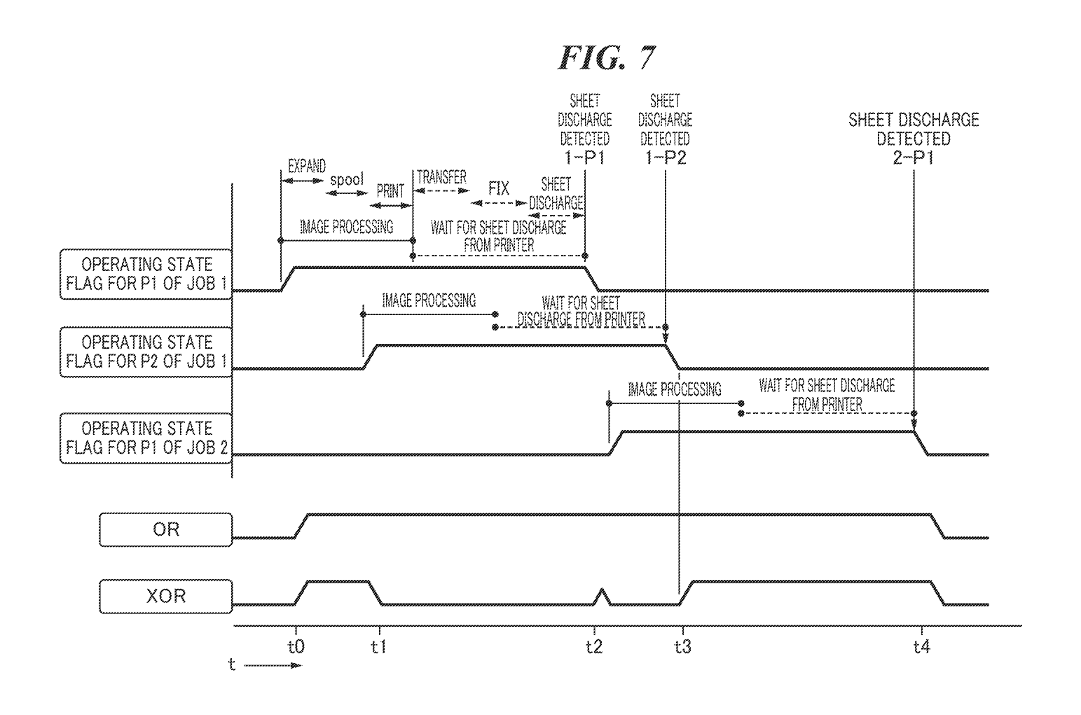

In the step S205, when the job is a print job such as PDL printing, fax print reception, or copying, the CPU 201 carries out a printing process (step S210). In the printing process, the CPU 201, for example, reads image data to be printed from the HDD 203 or writes the image data and execution log data on the printing process into the HDD 203. Then, based on the operating status flag for the print job application, the CPU 201 determines whether or not printing is for a last page (step S211). Here, in the present embodiment, in a case where a print job comprised of a plurality of pages is executed, different operating status flags are set for the respective pages. Also, in a case where a plurality of print jobs is sequentially executed, a plurality of operating status flags is set for the respective print jobs. For example, in a case where a print job 1 in which two pages are printed and a print job 2 in which one page is printed are sequentially executed in this order, an operating status flag_1-P1 for the first page of the print job 1, an operating status flag_1-P2 for the second page of the print job 1, and an operating status flag_2-P1 for the first page of the print job 2 are set to “0” or “1” (see, for example, FIG. 7). In the step S211, the CPU 201 determines that printing is for the last page when XOR of all the operating state flags described above is “1” and the operating status flag for the print job 2 to be executed second is set to “1”, and otherwise, the CPU 201 determines that printing is not for the last page.

As a result of the determination in the step S211, when printing is not for the last page, the process returns to the step S210. On the other hand, as a result of the determination in the step S211, when printing is for the last page, the CPU 201 determines whether or not printed matter for the last page has been discharged (step S212).

As a result of the determination in the step S212, when the printed matter for the last page has not been discharged, the process returns to the step S210.

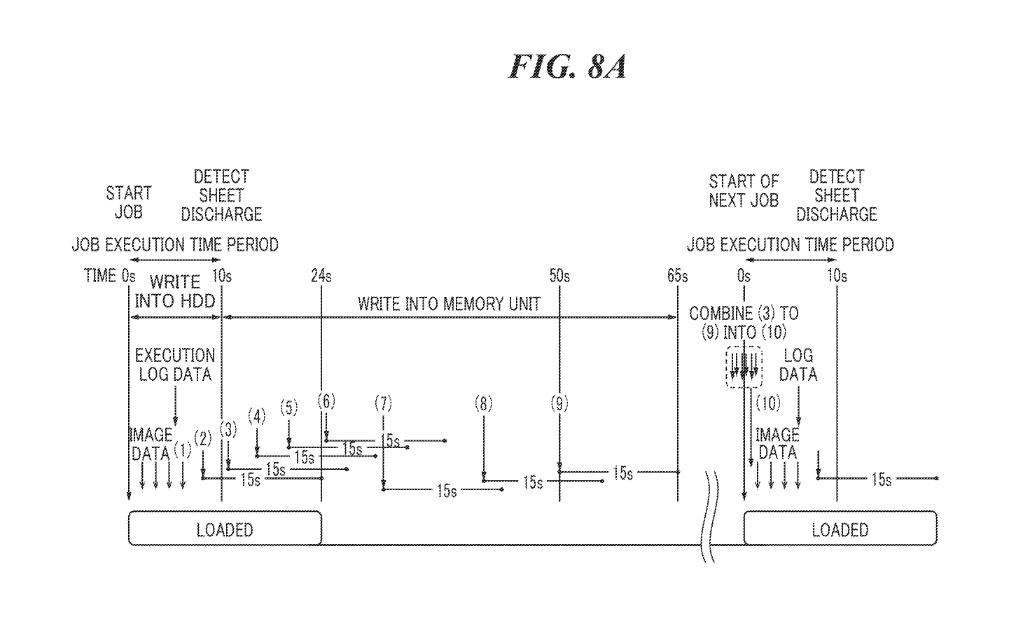

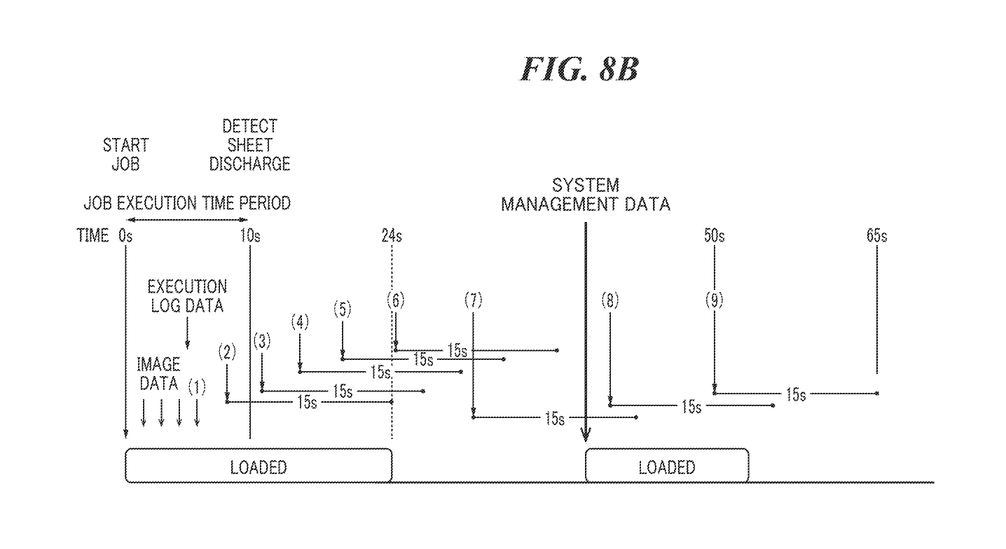

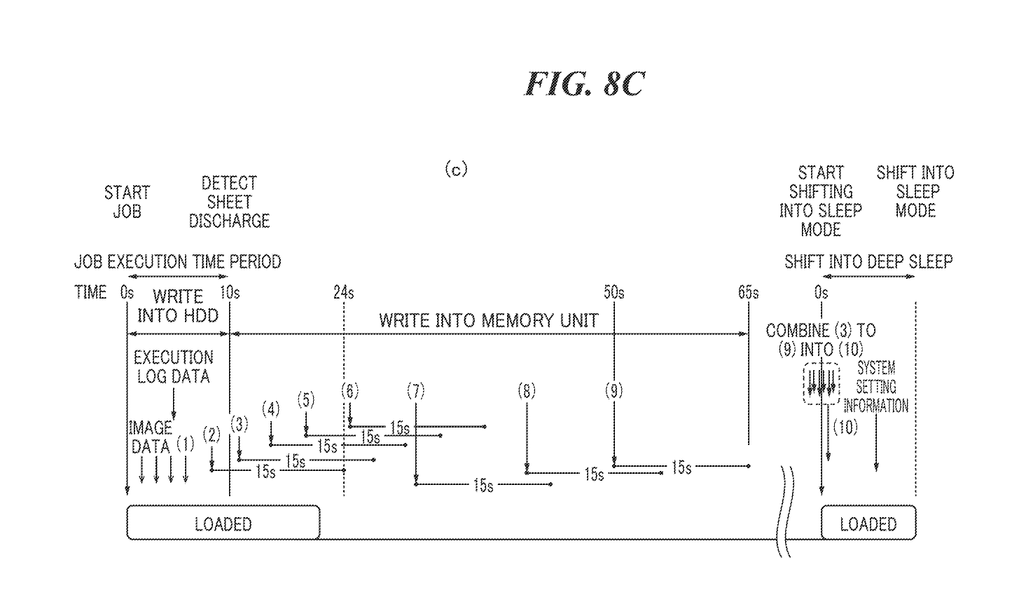

As a result of the determination in the step S212, when the printed matter for the last page has been discharged, as a result of the determination in the step S207, when transmission of all the designated image data has been completed, or as a result of the determination in the step S209, when all the targeted image data has been stored, the CPU 201 makes the HDD write stop setting (step S213). The CPU 201 also sets, in the memory unit 202, destinations in which respective pieces of data are to be recorded. After that, when the need to write data associated with execution of the job, and more specifically, the need to write status log data arises as shown in (3) to (9) in FIG. 5, the CPU 201 writes the status log data as held log data in the memory unit 202 (step S214). The held log data and data for use in a next job are collectively written into the HDD 203 by the process in the step S204 when the CPU 201 is instructed to start the next job (see, for example, (10) in FIG. 8A). After that, the process returns to the step S201.

As a result of the determination in the step S201, when the CPU 201 has not been instructed to start the job, it determines whether or not it has received an instruction to write system management data (step S215).

As a result of the determination in the step S215, when the CPU 201 has received the instruction to write the system management data, the CPU 201 allows writing of the system management data into the HDD 203. The system management data is comprised of information about network settings on the MFP 10 and group settings related to authentication, a telephone book, and information about sleep settings, and so forth. If the system management data is not written into the HDD 203, it would become impossible to carry out a communication process and an authentication process in the MFP 10. To cope with this, in the present embodiment, when the CPU 201 receives an instruction to write the system management data in the state where the HDD write stop setting has been made, the CPU 201 allows writing of the system management data. The CPU 201 writes the system management data into the HDD 203 (step S216) (see, for example, FIG. 8B), and the process returns to the step S101.

As a result of the determination in the step S215, when the CPU 201 has not received the instruction to write the system management data, the CPU 201 determines whether or not it has received an instruction to shift into the sleep mode or an instruction to shut down the MFP 10 (step S217).

As a result of the determination in the step S217, when the CPU 201 has received neither the instruction shift into the sleep mode nor the instruction to shut down the MFP 10, the CPU 201 carries out the processes in the step S214 and the subsequent steps.

As a result of the determination in the step S217, when the CPU 201 has received the instruction shift into the sleep mode or the instruction to shut down the MFP 10, the CPU 201 determines whether or not the held log data is present (step S218).

As a result of the determination in the step S218, when the CPU 201 determines that the held log data is not present, the CPU 201 carries out a process in step S220, to be describe later. On the other hand, as a result of the determination in the step S218, when the CPU 201 determines that the held log data is present, the CPU 201 writes the held log data into the HDD 203 (step S219) (see, for example, FIG. 8C). The CPU 201 also writes system setting information, which is required at the time of return from the sleep mode or at the time of starting, into the HDD 203 (step S220). Namely, in the present embodiment, the held log data and the system setting information are collectively written into the HDD 203. Then, the CPU 201 carries out a process according to the received instruction, and more specifically, a process to shift into the sleep mode or a shutdown process (step S221) and ends the present process.

According to the process in FIG. 7 described above, in the MFP 10 which writes multiple pieces of data associated with execution of a received job into the HDD 203, a part of the multiple pieces of data is written into the memory unit 202, not the HDD 203. Namely, in the HDD 203, the loaded state does not have to be maintained until writing of all the data associated with execution of the job is completed. This prevents the total loading time from unnecessarily increasing while efficiently reading and writing data from and into the HDD 203 by reducing the travel distance of the head 203 to a minimum. As a result, performance of the MFP 10 is improved without shortening the life span of the HDD 203.

The MFP 10, which is an example of an information processing apparatus that executes a received job, performs processing as explained hereafter.

First, data on the job is written into the HDD 203, which is an example of a storage device having a disk head. Thus, the CPU 201 provides control such that the time period during which the disk head is loaded over a disk is shorter in a case where at least the need to read and write data from and into the HDD 203 does not arise in data processing based on execution of the job than in a case where the need to read and write data from and into the HDD 203 arises. Thus, the MFP 10 provides control so that the total loading time of the HDD 203 can be short. Namely, the ratio of the total time period during which the power to the MFP 10 is on to the total loading time is controlled to be not larger than a predetermined ratio.

Moreover, in the process in FIG. 7 described above, a part of data is written at times other than the time period during which the job is executed. Data written at times other than the time period during which a job is executed is not used at least for execution of the job, and therefore, even if the data is not written into the HDD 203, execution of the job never slows down, and performance of the MFP 10 never deteriorates. As a result, in the process in FIG. 7 described above, the life span of the HDD 203 is prevented from being shortened without causing performance of the MFP 10 to deteriorate.

Further, in the process in FIG. 7 described above, a part of data associated with execution of the job is status log data varying with execution of the job. The status log data includes information indicating an operating state of the MFP 10 and information indicating statuses of consumables used by the MFP 10. Here, even if the information indicating information on the operating state of the MFP 10 and the information indicating the statuses of the consumables used by the MFP 10 are not updated to latest information immediately after execution of the job is completed, execution of the job never slows down, and performance of the MFP 10 never deteriorates. In the process in FIG. 7 described above, some data is the status log data including information indicating an operating state of the MFP 10 and information indicating statuses of consumables used by the MFP 10. As a result, a situation in which performance of the MFP 10 is caused to deteriorate by preventing the life span of the HDD 203 from being shortened is avoided.

In the embodiment described above, when another job received subsequently to the job is executed, the status log data held in the memory unit 202 is written into the HDD 203. Namely, the held log data and the status log data are collectively written into the HDD 203 when data is read and written during execution of the other job, and therefore, the total loading time is never caused to unnecessarily increase by writing the held log data. As a result, the held log data is written into the HDD 203 without shortening the life span of the HDD 203.

Moreover, in the process in FIG. 7 described above, when the MFP 10 is shut down, the status log data held in the memory unit 202 is written into the HDD 203. The status log data held in the memory unit 202 is also written into the HDD 203 when the MFP 10 shifts into the sleep mode. Here, the system setting information is written into the HDD 203 when the MFP 10 is shut down and when the MFP 10 shifts into the sleep mode. For this reason, even if the status log data held in the memory unit 202 is written into the HDD 203 at this time, the total loading time is never caused to unnecessarily increase by writing the held log data. In the process in FIG. 7 described above, the status log data held in the memory unit 202 is written into the HDD 203 when the MFP 10 is shut down or when the MFP 10 shifts into the sleep mode. As a result, the status log data is written into the HDD 203 without unnecessarily increasing the total loading time.

It should be noted that in the process in the step S216, the held log data may also be written into the HDD 203 when the system management data is written into the HDD 203.

Moreover, in the embodiment described above, when the amount of the held log data has exceeded a threshold value determined in advance, the held log data may be stored in the HDD 203. This enables the held log data to be written into the HDD 203 without shortening the life span of the HDD 203.

Further, in the embodiment described above, the held log data may be held in modules other than the memory unit 202.

Here, the memory unit 202 stores other data in addition to the held log data, and hence if a large the held log data in a large data amount is held for a long period of time, the capacity of the memory unit 202 would be tighten, making it impossible to carry out processes in the MFP 10 and causing performance of the MFP 10 to deteriorate.

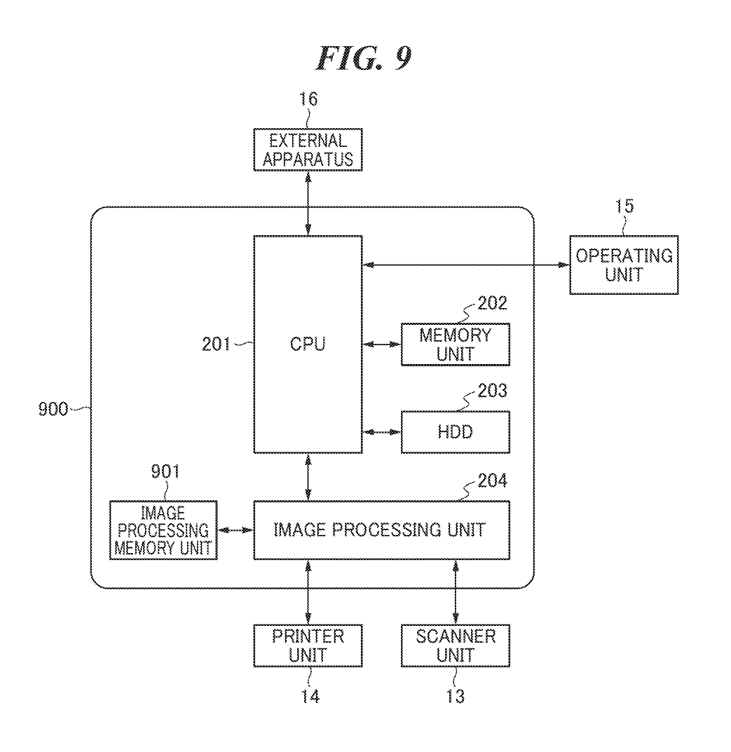

To cope with this, in the present embodiment, the held log data is held in an image processing memory unit 901 in FIG. 9.

FIG. 9 is a block diagram schematically showing an arrangement of a variation of the main controller 12 in FIG. 1.

Referring to FIG. 9, a main controller 900 has the image processing memory unit 901 as well as the CPU 201, the memory unit 202, the HDD 203, and the image processing unit 204 in FIG. 2.

The image processing memory unit 901 is connected to the image processing unit 204. The image processing memory unit 901 is used as work memory when the image processing unit 204 performs image processing in a job. The image processing memory unit 901 is used only when a job is executed. Namely, the image processing memory unit 901 is not used during a job waiting period from when execution of a job is completed to when a next job is executed. For this reason, even if the image processing memory unit 901 holds the held log data only during the job waiting period, use of the image processing memory unit 901 for other purposes is never hindered, and performance of the MFP 10 is never caused to deteriorate by holding the held log data. In the present embodiment, since the image processing memory unit 901 holds the held log data, the held log data is held without causing performance of the MFP 10 to deteriorate.

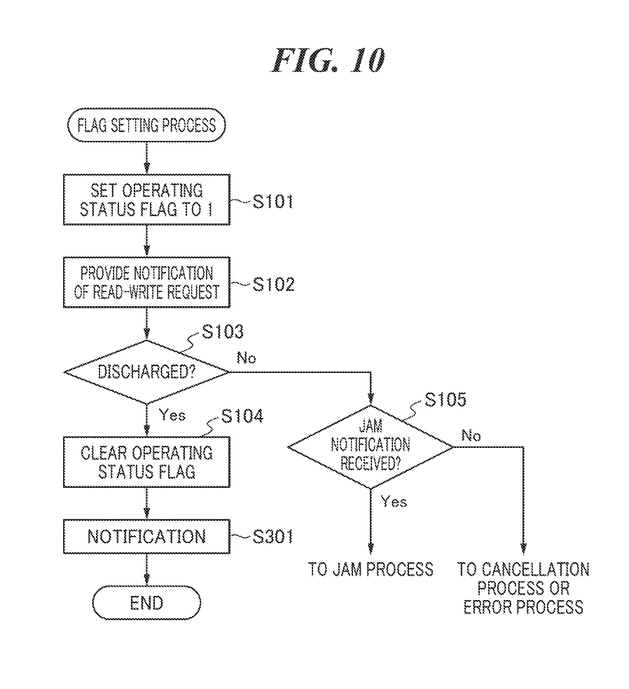

FIG. 10 is a flowchart showing the procedure of a variation of the flag setting process in FIG. 4.

The process in FIG. 10 is implemented by the CPU 201 of the main controller 900 executing programs stored in the HDD 203. The process in FIG. 10 is also based on the assumption that, for example, a flag is set for the print job application among the plurality of job applications installed in the MFP 10.

Referring to FIG. 10, the CPU 201 carries out the processes in the steps S101 to S103.

As a result of the determination in the step S103, when no printed matter has been discharged, the CPU 201 carries out the processes in the step S105 and the subsequent steps. As a result of the determination in the step S103, when printed matter has been discharged, the CPU 201 carries out the process in the step S104. After that, when the need to write data associated with execution of the job, and more specifically, the need to write status log data arises as shown in (3) to (9) in FIG. 5, the CPU 201 writes the status log data as held log data in the image processing memory unit 901. Then, the CPU 201 notifies the OS that the held log data is held in the image processing memory unit 901 (step S301) and ends the present process.

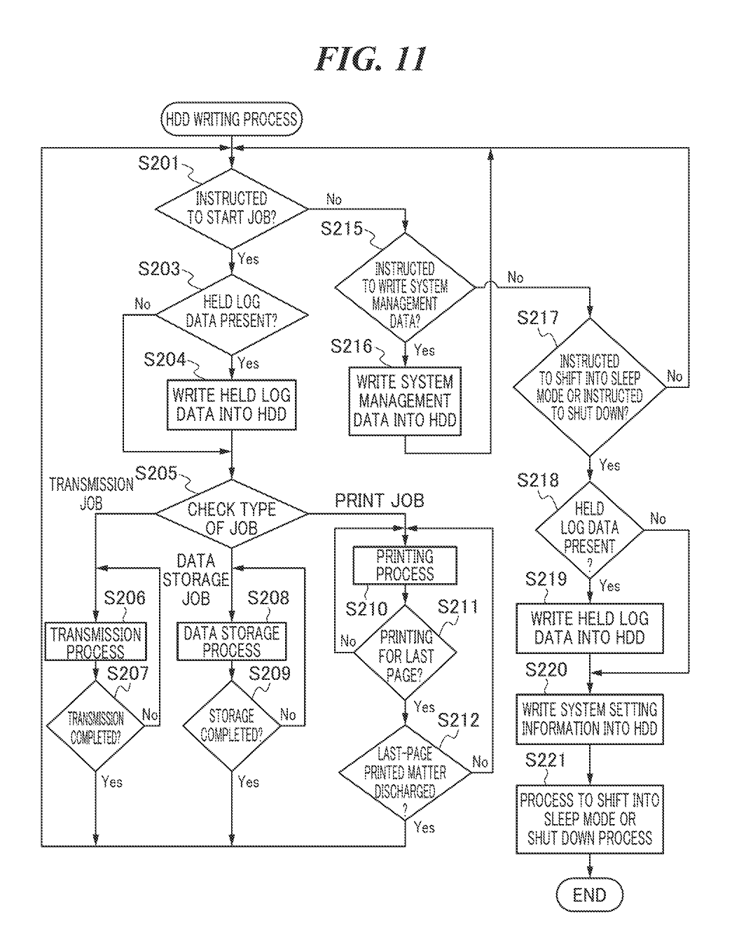

FIG. 11 is a flowchart showing the procedure of a variation of the HDD writing process in FIG. 6.

The process in FIG. 11 is implemented by the CPU 201 of the main controller 900 executing programs stored in the HDD 203 and carried out when the MFP 10 has shifted into the standby mode.

The flowchart of FIG. 11 differs from the flowchart of FIG. 5 in processes carried out when the CPU 201 has been instructed to start the job as a result of the determination in the step S201, when transmission of all the designated image data has been completed as a result of the determination in the step S207, when all the targeted image data has been stored as a result of the determination in the step S209, when the printed matter for the last page has been discharged as a result of the determination in the step S212, and when neither the instruction to shift into the sleep mode nor the instruction to shut down the MFP 10 has been received as a result of the determination in the step S217, and therefore, only processes different those in the flowchart of FIG. 5 will be described below.

As a result of the determination in the step S201, when the CPU 201 has been instructed to start the job, the CPU 201 carries out the processes in the steps S203 to S212.

As a result of the determination in the step S207, when transmission of all the designated image data has been completed, as a result of the determination in the step S209, when all the targeted image data has been stored, as a result of the determination in the step S212, when the printed matter for the last page has been discharged, or as a result of the determination in the step S217, when neither the instruction to shift into the sleep mode nor the instruction to shut down the MFP 10 has been received, the process returns to the step S201. The held log data held in the image processing memory unit 901 is written into the HDD 203 when a next job is executed, when the MFP 10 shifts into the sleep mode, or when the MFP 10 is shut down.

### Other Embodiments

Embodiment(s) of the present invention can also be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-208475, filed Oct. 27, 2017, which is hereby incorporated by reference herein in its entirety.

What is claimed is:

1. An image forming apparatus that executes a received job, comprising:
a generating unit configured to generate multiple pieces of data related to execution of the job;
a nonvolatile storage unit configured to store data;
a volatile holding unit configured to hold data; and
a control unit configured to cause the storage unit to store data generated during a job execution time period during which the job is executed among the multiple pieces of data, and cause the holding unit to hold data generated at times other than the job execution time period among the multiple pieces of data.

2. The image forming apparatus according to claim 1, wherein the control unit causes the holding unit to hold data generated from end of the job execution time period to start of another job execution time period during which another job received subsequently to the job.

3. The image forming apparatus according to claim 2, wherein based on start of the other job execution time period, the control unit causes the storage unit to store data held in the holding unit.

4. The image forming apparatus according to claim 1, wherein based on shutdown of the image forming apparatus, the control unit causes the storage unit to store data held in the holding unit.

5. The image forming apparatus according to claim 1, wherein based on the image forming apparatus shifting into a power saving mode, the control unit causes the storage unit to store data held in the holding unit.

6. The image forming apparatus according to claim 1, wherein in response to the amount of data held in the holding unit exceeding a data amount determined in advance, the control unit causes the storage unit to store data held in the holding unit.

7. The image forming apparatus according to claim 1, further comprising an image processing unit configured to perform image processing in the job,
wherein the holding unit is a temporary storage unit that is used when the image processing unit performs the image processing.

8. The image forming apparatus according to claim 1, wherein the multiple pieces of data are data indicating a status of the image forming apparatus that varies with execution of the job.

9. The image forming apparatus according to claim 8, wherein the data indicating the status of the image forming apparatus includes information on an operating state of the image forming apparatus and information indicating statuses of consumables used by the image forming apparatus.

10. The image forming apparatus according to claim 9, wherein among the data indicating the status of the image forming apparatus, data generated at times other than the job execution time period is data that has varied with execution of the job.

11. The image forming apparatus according to claim 1, wherein the generating unit further generates execution log data based on execution of the job, and
the control unit causes the storage unit to store the execution log data.

12. The image forming apparatus according to claim 1, wherein the job is a print job.

13. The image forming apparatus according to claim 12, wherein the job execution time period is a time period that elapses from when execution of the print job is started to when printed matter is discharged.

14. A control method for an image forming apparatus that has a nonvolatile storage unit that stores data related to execution of a received job, and a volatile holding unit that holds data, comprising:
a generating step of generating multiple pieces of data related to execution of the job; and
a control step of causing the storage unit to store data generated during a job execution time period during which the job is executed among the multiple pieces of data, and causing the holding unit to hold data generated at times other than the job execution time period among the multiple pieces of data.

15. A non-transitory computer-readable storage medium storing a program for causing a computer to execute a control method for an image forming apparatus that has a nonvolatile storage unit that stores data related to execution of a received job, and a volatile holding unit that holds data, the control method for the image forming apparatus comprising:
a generating step of generating multiple pieces of data related to execution of the job; and
a control step of causing the storage unit to store data generated during a job execution time period during which the job is executed among the multiple pieces of data, and causing the holding unit to hold data generated at times other than the job execution time period among the multiple pieces of data.
